(19) United States
(12) Patent Application Publication
(10) Pub. No.: US 2009/0151425 A1
(43) Pub. Date: Jun. 18, 2009

(54) NOx SENSOR DIAGNOSTIC DEVICE FOR INTERNAL COMBUSTION ENGINE

(75) Inventor: Makoto MIWA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/332,580

(22) Filed: Dec. 11, 2008

(30) Foreign Application Priority Data
Dec. 14, 2007 (JP) 2007-323306

(51) Int. Cl. G01N 7/00

(52) U.S. Cl. 73/23.31

(57) ABSTRACT

A NOx sensor diagnostic device for an internal combustion engine includes a NOx sensor disposed in the exhaust passage of the engine, through which exhaust air discharged from the engine flows, and configured to detect nitrogen oxide included in the exhaust air, an air supply device for supplying air to the exhaust passage, and a sensor determination device for making the NOx sensor detect nitrogen oxide in the exhaust passage, to which air is supplied by the air supply device while the engine is stopped, and for determining that the NOx sensor is abnormal when an output value of the NOx sensor is equal to or larger than a predetermined reference value.

### CROSS REFERENCE TO RELATED APPLICATION

This application is based on and incorporates herein by reference Japanese Patent Application No. 2007-323306 filed on Dec. 14, 2007.

### BACKGROUND OF THE INVENTION

1. Field of the Invention

The present invention relates generally to a NOx sensor diagnostic device for an internal combustion engine, and more particularly to a NOx sensor diagnostic device which detects NOx in exhaust air.

2. Description of Related Art

A NOx sensor which detects NOx in exhaust air needs to be regularly diagnosed in order to maintain its accuracy and to find whether failure has occurred at an early stage. In JP2006-105965A, the output of a NOx sensor is diagnosed until an internal combustion engine resumes operation after it has been stopped. In JP2006-105965A, the output of the NOx sensor is diagnosed when an excess air ratio in an exhaust passage of the engine becomes large enough after the engine has stopped operation.

However, in the NOx sensor, a slight amount of NOx contained in exhaust air needs to be detected In recent years, in particular, a slight amount of NOx included in exhaust air needs to be treated, and the NOx sensor is required to have high detection accuracy near a zero point at which concentration of NOx is 0 (zero). Even when the engine has stopped operation and the excess air ratio in the exhaust passage becomes large enough, such as in JP2006-105965A, NOx remains in the exhaust passage. In other words, even when the excess air ratio in the exhaust passage is large enough, NOx concentration is not necessarily low. Accordingly, in JP2006-105965A, the diagnosis of the NOx sensor is susceptible to NOx which remains in the exhaust passage, and thus accuracy of the diagnosis is difficult to ensure.

### SUMMARY OF THE INVENTION

The present invention addresses the above disadvantages. Thus, it is an objective of the present invention to provide a NOx sensor diagnostic device for an internal combustion engine, which reduces influence of NOx contained in exhaust air so as to improve diagnostic accuracy of a NOx sensor particularly near a zero point.

To achieve the objective of the present invention, there is provided a NOx sensor diagnostic device for an internal combustion engine having an exhaust passage. The device includes a NOx sensor, an air supply means, and a sensor determination means. The NOx sensor is disposed in the exhaust passage, through which exhaust air discharged from the engine flows, and is configured to detect nitrogen oxide included in the exhaust air. The air supply means is for supplying air to the exhaust passage. The sensor determination means is for making the NOx sensor detect nitrogen oxide in the exhaust passage, to which air is supplied by the air supply means while the engine is stopped, and is for determining that the NOx sensor is abnormal when an output value of the NOx sensor is equal to or larger than a predetermined reference value.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram illustrating a NOx sensor diagnostic device according to a first embodiment of the present invention;

FIG. 2 is a schematic diagram illustrating an engine system to which the NOx sensor diagnostic device according to the first embodiment is applied;

FIG. 3 is a schematic diagram illustrating a flow of operation of the NOx sensor diagnostic device according to the first embodiment;

FIG. 4 is a timing diagram of the NOx sensor diagnostic device according to the first embodiment;

FIG. 5 is a schematic diagram illustrating an engine system to which a NOx sensor diagnostic device according to a second embodiment of the present invention is applied; and

FIG. 6 is a flowchart illustrating a flow of operation of the NOx sensor diagnostic device according to the second embodiment.

### DETAILED DESCRIPTION OF THE INVENTION

Embodiments of an engine system to which a NOx sensor diagnostic device according to the invention is applied are described below with reference to drawings. The same numerals are used to indicate substantially the same parts in the following embodiments, and their overlapping descriptions are omitted.

### First Embodiment

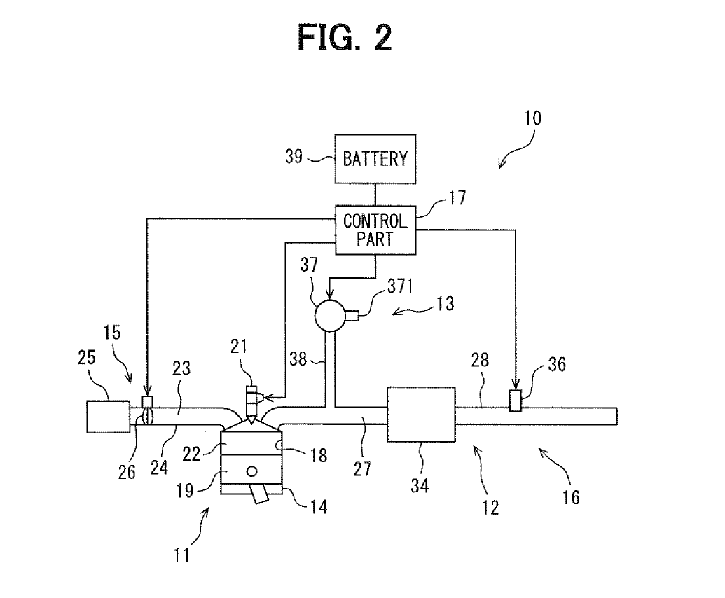

An engine system, to which a NOx sensor diagnostic device according to a first embodiment of the invention is applied, is explained below with reference to FIG. 2. An engine system 10 includes an engine 11 as an internal combustion engine, an exhaust emission control device 12, and an air supply unit 13 as an air supply means. Any internal combustion engine, such as a piston engine (e.g. a gasoline engine or a diesel engine) or a gas-turbine engine, is applied to the engine 11, for example. In the first embodiment, an example, in which a gasoline engine is applied as the engine 11, will be explained. The engine 11 includes an engine main body 14, a suction system 15, an exhaust system 16, and a control part 17. The engine main body 14 includes a piston 19 which reciprocates inside a cylinder 18. An injector 21 which injects fuel is provided for the cylinder 18. The injector 21 injects fuel into a combustion chamber 22 formed between the cylinder 18 and the piston 19. Fuel is supplied to the injector 21 from a fuel tank (not shown). In the first embodiment, the engine 11 is an engine, in which fuel is injected from the injector 21 into the combustion chamber (i.e. a direct injection-type engine). The method of supplying fuel in the engine 11 is not limited to the direct injection-type, and any method such as a premixing type may be chosen.

The suction system 15 includes a suction pipe part 24 which defines a suction passage 23. One end portion of the suction pipe part 24 is connected to the engine main body 14, and the other end portion of the suction pipe part 24 is open to the atmosphere. The suction pipe part 24 has an air filter 25 at its end portion that is open to the atmosphere. Intake air is suctioned into the engine main body 14 via the suction passage 23 which the suction pipe part 24 defines after removal of foreign substances through the air filter 25. The suction system 15 has a throttle 26. The throttle 26 controls a flow of intake air flowing through the suction passage 23 by opening or closing the suction passage 23. A suction valve (not shown) is provided at an end of the suction passage 23 on a combustion chamber 22 side. When the suction valve opens or closes, the flow of intake air from the suction passage 23 into the combustion chamber 22 continues or stops The throttle 26 constitutes a “valve means”. Instead of the throttle 26, the flow of the intake air suctioned into the combustion chamber 22 may be controlled according to opening/closing timing and an amount of the opening/closing of the suction valve. In this case, the suction valve constitutes the “valve means”.

The exhaust system 16 includes an exhaust pipe part 28 which defines an exhaust passage 27. One end portion of the exhaust pipe part 28 is connected to the engine main body 14, and the other end portion of the exhaust pipe part 28 is open to the atmosphere through a muffler (not shown). The exhaust air is discharged from the engine main body 14 to the atmosphere through the exhaust passage 27 which the exhaust-pipe part 28 defines. An exhaust valve (not shown) is provided at an end of the exhaust passage 27 on the combustion chamber 22 side. When the exhaust valve opens or closes, the outflow of exhaust air from the combustion chamber 22 to the exhaust passage 27 continues or stops.

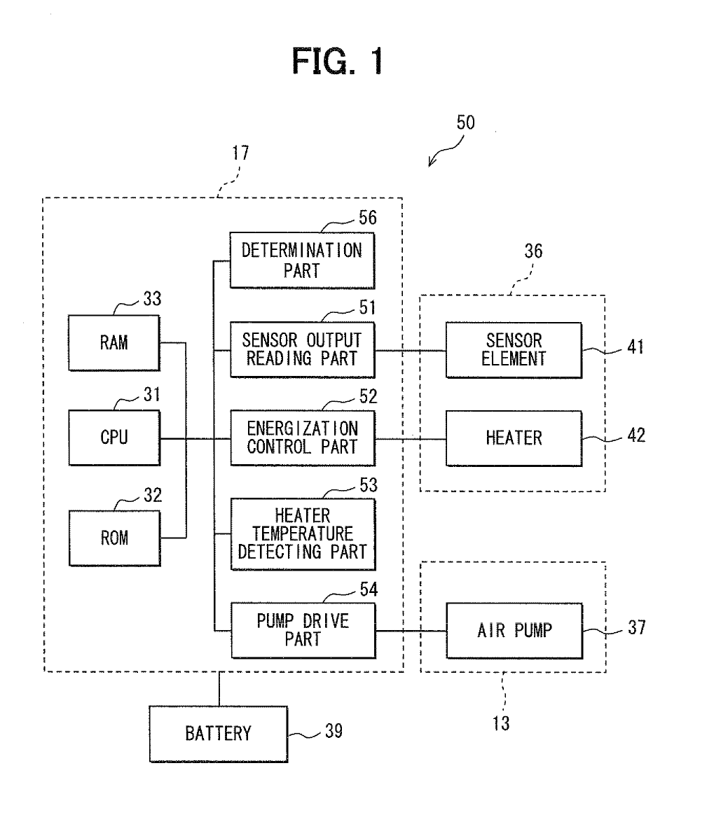

The control part 17 is an ECU (Electronic Control Unit) for controlling the entire engine system 10 including the engine 11 and the exhaust emission control device 12. As shown in FIG. 1, the control part 17 is a microcomputer including a central processing unit (CPU) 31, a read-only memory (ROM) 32, and a random access memory (RAM) 33. The control part 17 is connected to the other control units of the engine system 10 via an in-vehicle LAN (not shown). The control part 17 outputs a driving signal to the injector 21 based on, for example, a depression amount of an accelerator pedal (not shown). The control part 17 controls an opening/closing period of the injector 211 i.e. an injection amount of fuel by outputting the driving signal to the injector 21.

As shown in FIG. 2, the exhaust emission control device 12 has a three-way catalyst 34 and a NOx sensor 36. Both the three-way catalyst 34 and the NOx sensor 36 are provided in the exhaust system 16. The three-way catalyst 34 oxidizes hydrocarbon (HC) contained in exhaust air into water (H2O) and carbon dioxide (CO2), when its temperature reaches an active temperature. The three-way catalyst 34 reduces nitrogen oxide (NOx) contained in exhaust air into nitrogen (N2). Not only the three-way catalyst 34, but also, for example, other catalysts such as an ammonia oxidation catalyst, a NOx selective reduction catalyst, and a NOx storage catalyst, may be disposed in the exhaust passage 27.

The NOx sensor 36 is disposed on a downstream side of the three-way catalyst 34 in a flow direction of exhaust air in the exhaust system 16. The NOx sensor 36 detects concentration of NOx contained in exhaust air flowing through the exhaust passage 27. As shown in FIG. 1, the NOx sensor 36 has a widely known configuration including a sensor element 41 and a heater 42. The sensor element 41 has, for example, a pair of electrodes (not shown). Solid electrolyte is placed between the pair of electrodes of the sensor element 41. The heater 42 heats the sensor element 41. Accordingly, the sensor element 41 is heated to the active temperature by the heater 42.

The air supply unit 13 includes an air pump 37 and a discharge passage part 38. The air pump 37 is driven by electric power supplied from a battery 39 via the control part 17. The air pump 37 suctions air through an inlet 371 that is open to the atmosphere, when the electric power is supplied to the air pump 37. Then, the air pump 37 pressurizes the suctioned air and discharges it. The air pump 37 supplies fresh air to the catalyst when oxygen concentration in exhaust air reduces. Accordingly, oxidation reaction or a reduction reaction of the three-way catalyst 34 is maintained by the fresh air supplied by the air pump 37, i.e., a secondary air. In the above-described manner, the air pump 37 may be included in the engine system 10 for supplying the secondary air. In this case, the air pump 37 of the engine system is used not only for the supply of the secondary air but also for diagnosis of the NOx sensor 36 of the first embodiment.

The discharge passage part 38 connects the air pump 37 and the exhaust passage 27. More specifically, the discharge passage part 38 is connected to the exhaust passage 27 between the engine main body 14 and the three-way catalyst 34. Accordingly, air discharged from the air pump 37 is supplied to an upstream side of the three-way catalyst 34 in the flow direction of exhaust air via the discharge passage part 38.

A configuration of a diagnostic device 50 of the NOx sensor 36 is described in detail. As shown in FIG. 1, the diagnostic device 50 includes the control part 17, the NOx sensor 36, and the air supply unit 13 of the engine system 10. As above, the control part 17 is the microcomputer including the CPU 311 the ROM 32, and the RAM 33. The control part 17 includes a sensor output reading part 511 an energization control part 52, a heater temperature detecting part 531 a pump drive part 54, and a determination part 56. The sensor output reading part 51 is connected to the sensor element 41 of the NOx sensor 36. An electrical signal associated with NOx concentration outputted from the sensor element 41 is inputted into the sensor output reading part 51. The control part 17 detects the NOx concentration included in the exhaust air flowing through the exhaust passage 27 based on the electrical signal inputted into the sensor output reading part 51.

The energization control part 52 is connected to the heater 42 of the NOx sensor 36. The energization control part 52 turns on or off the energization of the heater 42. Accordingly, the supply of the electric power by the battery 39 is maintained or stopped with respect to the heater 42. The heater temperature detecting part 53 detects temperature of the heater 42. In the first embodiment, the heater temperature detecting part 53 detects a voltage applied to the heater 42 and an electric current supplied to the heater 42 by the energization control part 52. The heater temperature detecting part 53 detects the temperature of the heater 42, based on a relationship between the voltage applied to the heater 42 and the electric current supplied to the heater 42. The pump drive part 54 maintains or stops the supply of the electric power to the air pump 37 by the battery 39. When the pump drive part 54 allows the supply of the electric power to the air pump 37 by the battery 39, the air pump 37 is driven. The determination part 56 determines whether abnormality of the NOx sensor 36 exists, in accordance with a computer program stored in the ROM 32 or other storage portions. The determination part 56 constitutes a “sensor determination means”.

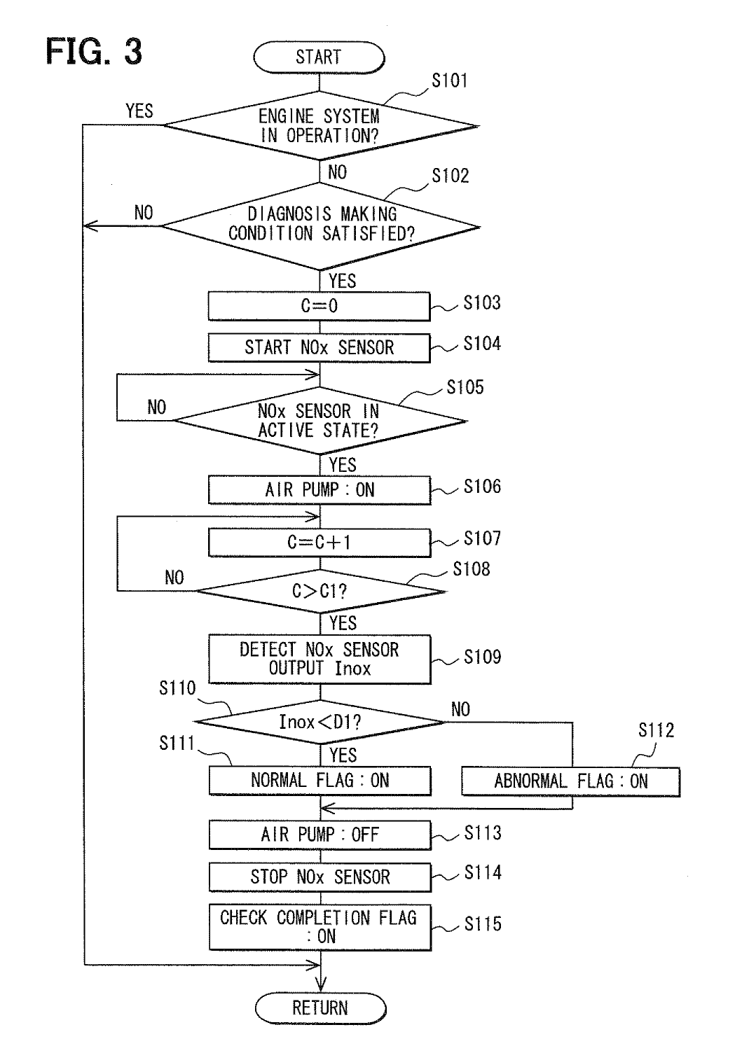

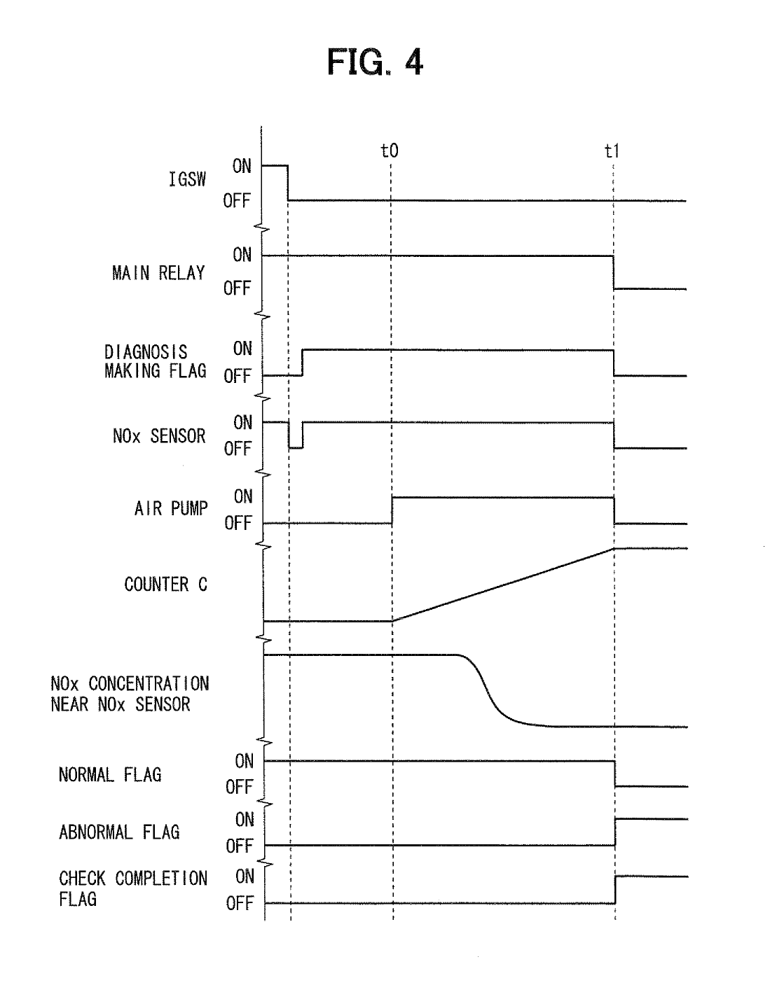

A flow of the diagnosis of the NOx sensor 36 including the determination of the abnormality of the NOx sensor 36 by the determination part 56 is described below with reference to FIG. 3 and FIG. 4. A main relay (not shown) of the control part 17 maintains its activation status during a predetermined period, even after ignition switch (IGSW: not shown) of the engine system 10 is turned off. The control part 17 performs a computer program about various diagnoses of the NOx sensor 36 including the determination of the abnormality of the NOx sensor 36 while the main relay is being activated. Meanwhile, the period during which the main relay maintains its activation status may be set at any period, for example, about several minutes.

The determination part 56 performs the computer program stored in the ROM 32, when a diagnosis making flag is turned on with the main relay being activated. Accordingly, the determination part 56 first determines whether the engine system 10 is operating (S101). When the ignition switch is turned off, for example, it is highly possible that the operation of the engine system 10 is stopped. Nevertheless, the determination part 56 determines for confirmation whether the engine system 10 is operating, and whether the engine system 10 is in a starting status. The determination part 56 detects a state of the engine system 10 based on, for example, the injection amount of fuel from the injector 21, a rotational speed of the engine main body 14 detected by a rotation sensor (not shown), or the like.

When the determination part 56 determines that the engine system 10 has stopped at S101, the determination part 56 determines whether a diagnosis making condition is satisfied (S102). The determination part 56 determines whether the voltage of the battery 39 is equal to or larger than a predetermined lower limit, as the diagnosis making condition. When an amount of charge of the battery 39 has been reduced, or the battery 39 has deteriorated, for example, the voltage of the battery 39 may be smaller than the lower limit. The diagnosis of the NOx sensor 36 involves energization of the air pump 37 and the energization of the heater 42 of the NOx sensor 36. Accordingly, if the NOx sensor 36 is diagnosed when the voltage of the battery 39 is equal to or smaller than the lower limit due to the reduction of the amount of charge of the battery 39 or the deterioration of the battery 39, a load applied to the battery 39 becomes large. As a result, the next starting of the engine system 10 may be affected. Thus, when the voltage of the battery 39 is smaller than the lower limit, the determination part 56 determines that the diagnosis making condition is not satisfied, and stops the diagnosis of the NOx sensor 36. Alternatively, when an outside air temperature detected by an ambient temperature sensor (not shown) is extremely low, for example, below zero, the determination part 56 may determine that the diagnosis making condition is not satisfied so as to stop the diagnosis of the NOx sensor 36. This is because, when the outside air temperature is extremely low, the electric power consumed by the heater 42 of the NOx sensor 36 increases, and thereby the load applied to the battery 39 may increase.

If the determination part 56 determines at S102 that the diagnosis making condition for the NOx sensor 36 is satisfied, as described above, the determination part 56 initializes a counter, i.e., C=0 (S103). The configuration of the determination part 56 includes the counter (not shown). When the determination part 56 determines at S102 that the diagnosis making condition for the NOx sensor 36 is satisfied, the determination part 56 initializes the counter and starts operation of the NOx sensor 36 at S103 (S104). The NOx sensor 36 is temporarily turned off by turning off the ignition switch. Then, the NOx sensor 36 is turned on again upon the satisfaction of the diagnosis making condition. The determination part 56 starts the energization of the heater 42 of the NOx sensor 36, when the NOx sensor 36 is turned on. The determination part 56 energizes the heater 42 via the energization control part 52.

The determination part 56 checks the activity of the NOx sensor 36 to determine whether the NOx sensor 36 is in an active state (S105). The determination part 56 determines that the NOx sensor 36 is in an active state, when the heater 42 of the NOx sensor 36 reaches a predetermined active temperature and a detection signal is outputted from the sensor element 41 of the NOx sensor 36. The temperature of the heater 42 is detected by the heater temperature detecting part 53. The heater temperature detecting part 53 may detect the temperature of the heater 42 based on the voltage applied to the heater 42 and the electric current supplied to the heater 42 by the energization control part 52, as described above. In addition, the temperature of the heater 42 may be detected by a temperature sensor arranged near the heater 42.

If the determination part 56 determines at S105 that the NOx sensor 36 is in an active state, the determination part 56 activates the air pump 37 (S106). The determination part 56 supplies electric power to the air pump 37 by the battery 39 through the pump drive part 54. The start of the operation of the air pump 37 corresponds to t0 in a timing diagram shown in FIG. 4. Accordingly, air discharged from the air pump 37 is supplied to the exhaust passage 27. As a result of the supply of air to the exhaust passage 27 by the air pump 37, exhaust air which has remained in the exhaust passage 27 after the engine 11 is stopped is removed by the supplied air. Accordingly, exhaust air in the exhaust passage 27 is discharged into the outside. Upon actuation of the air pump 37, the determination part 56 advances the counter at predetermined time intervals, i.e., C=C+1 (S107). The determination part 56 continues the energization of the air pump 37 (S108) until a period of energization of the air pump 37 reaches a predetermined value C1, i.e., until a count of the counter reaches C>C1. As a result of the supply of air to the exhaust passage 27 by the air pump 37 until the count of the counter reaches C1, exhaust air in the exhaust passage 27 is fully discharged. Accordingly, the exhaust passage 27 is filled with fresh air supplied by the air pump 37. Meanwhile, the predetermined value C1 of the counter corresponding to the period of energization of the air pump 37 is set depending on, for example, length of the exhaust passage 27, volume of the exhaust passage 27, or a distance from a connection of the discharge passage part 38 and the exhaust passage 27 to the NOx sensor 36. Accordingly, when a period of the supply of air by the air pump 37 reaches the predetermined value C1 of the counter, exhaust air including NOx hardly remains near the NOx sensor 36 in the exhaust passage 27.

The determination part 56 detects an output value Inox of the NOx sensor 36 (S109), if the period of energization of the air pump 37 reaches the predetermined value C1. The NOx sensor 36 outputs an electrical signal to the sensor output reading part 51 in accordance with concentration of NOx in the exhaust passage 27. The determination part 56 detects the output value Inox of the NOx sensor 36 based on the electrical signal outputted to the sensor output reading part 51. Then, the determination part 56 determines whether the detected output value Inox of the NOx sensor 36 is smaller than a predetermined reference value D1 (S110).

If the detected output value Inox of the NOx sensor 36 is smaller than the reference value D1, the determination part 56 determines that the NOx sensor 36 is normal, and turns on a normal flag (S111) On the other hand, if the detected output value Inox of the NOx sensor 36 is equal to or larger than the reference value D1, the determination part 56 determines that the NOx sensor 36 is abnormal, and turns on an abnormal flag (S112). The output value Inox of the NOx sensor 36 obtained by the determination part 56 corresponds to the concentration of NOx in the exhaust passage 27. When the NOx sensor 36 is diagnosed, fresh air is supplied to the exhaust passage 27 by the air pump 37 at S106 described above. Consequently, exhaust air including NOx hardly remains in the exhaust passage 27. In this manner, if the output value Inox of the NOx sensor 36 is equal to or larger than the reference value D1 even though exhaust air including NOx hardly remains in the exhaust passage 27, it is highly possible that abnormality is caused in the NOx sensor 36. For this reason, if the detected output value Inox of the NOx sensor 36 is equal to or larger than the reference value D1, the determination part 56 determines that the NOx sensor 36 is abnormal.

The determination part 56 stops the air pump 37 (S113) after the determination part 56 turns on the normal flag at S111 or turns on the abnormal flag at S112. The determination part 56 stops the supply of electric power to the air pump 37 through the pump drive part 54 thereby to stop the air pump 37. Then, the determination part 56 stops the operation of the NOx sensor 36 (S114). The determination part 56 stops the energization of the heater 42 of the NOx sensor 36, and stops the NOx sensor 36. Furthermore, the determination part 56 turns on a check completion flag (S115). Accordingly, the diagnosis of the NOx sensor 36 is completed. The completion of the diagnosis of the NOx sensor 36 corresponds to t1 in the timing diagram shown in FIG. 4.

As has been previously described, in the first embodiment, fresh air is supplied to the exhaust passage 27 by the air pump 37 in diagnosing the NOx sensor 36. Accordingly, the exhaust air including NOx is discharged into the atmosphere from the exhaust passage 27. As a result, exhaust air including NOx hardly remains near the NOx sensor 36. In diagnosing the NOx sensor 36, the concentration of NOx in the exhaust passage 27 detected by the NOx sensor 36 is approximately 0 (zero). Consequently, influence of NOx in the exhaust passage 27 on the diagnosis of the NOx sensor 36 is reduced. On the other hand, when the output value Inox of the NOx sensor 36 is equal to or larger than the reference value D1 despite the fact that NOx hardly remains in the exhaust passage 27, it is highly possible that abnormality is caused in the NOx sensor 36. Therefore, accuracy in diagnosing the NOx sensor 36 particularly near a zero point is improved.

The exhaust passage 27 and the suction passage 23 may be connected via the combustion chamber 22, depending on a position of the suction valve or the exhaust valve, for example. In this case, air supplied to the exhaust passage 27 by the air supply unit 13 flows toward the suction passage 23 side via the combustion chamber 22, and thereby exhaust air in the exhaust passage 27 may be insufficiently discharged.

In the first embodiment, the suction passage 23 is closed by the throttle 26 in diagnosing the NOx sensor 36. For this reason, the air supplied to the exhaust passage 27 by the air pump 37 cannot be discharged into the atmosphere via the combustion chamber 22 and the suction passage 23. As a result, the air discharged from the air pump 37 is used for the discharge of exhaust air which remains in the exhaust passage 27. Thus, the exhaust air in the exhaust passage 27 is discharged into the atmosphere for a short period of time.

In addition, in the first embodiment, whether the diagnosis of the NOx sensor 36 is performed is determined by the voltage of the battery 39. When the NOx sensor 36 is diagnosed, the operation of the air pump 37 and the operation of the heater 42 are involved. Both the air pump 37 and the heater 42 have comparatively large power consumption, so that the load applied to the battery 39 is large. If the NOx sensor 36 is diagnosed when the voltage of the battery 39 is lowered due to decrease or deterioration of its amount of charge, the next starting of the engine system 10 may be affected. Accordingly, by determining whether the diagnosis of the NOx sensor 36 is performed by the voltage of the battery 39, the load applied to the battery 39 is reduced. Therefore, the restart of the engine system 10 is reliably carried out.

### Second Embodiment

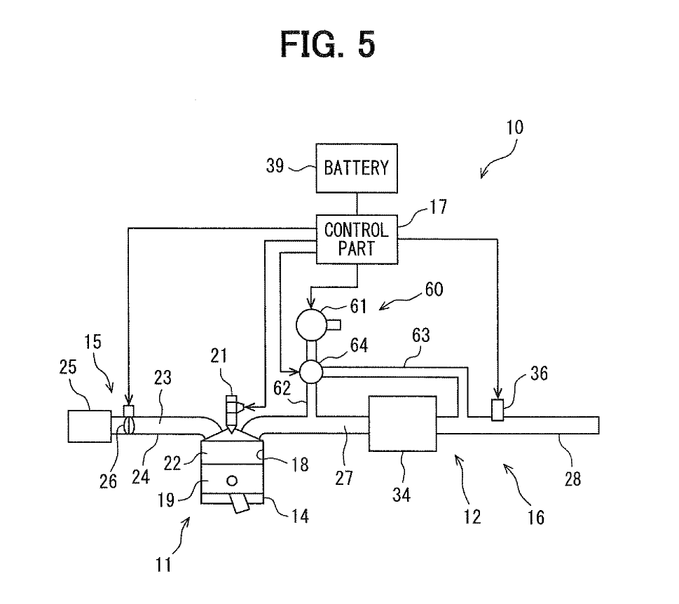

An engine system, to which a NOx sensor diagnostic device according to a second embodiment of the invention is applied, is shown in FIG. 5. As shown in FIG. 5, an air supply unit 60 of an engine system 10 includes an air pump 61, a catalyst passage part 62, a sensor passage part 63, and a changeover valve 64. The catalyst passage part 62 connects the air pump 61 and an exhaust passage 27. More specifically, the catalyst passage part 62 is connected to the exhaust passage 27 between an engine main body 14 and a three-way catalyst 34. Accordingly, air discharged from the air pump 61 is supplied to an upstream side of the three-way catalyst 34 in a flow direction of exhaust air via the catalyst passage part 62.

The sensor passage part 63 connects the air pump 61 and the exhaust passage 27. More specifically, the sensor passage part 63 is connected to the exhaust passage 27 between the three-way catalyst 34 and a NOx sensor 36. As a result, the air discharged from the air pump 61 is supplied to an upstream side of the NOx sensor 36 as well as to a downstream side of the three-way catalyst 34 in the flow direction of exhaust air via the sensor passage part 63. The changeover valve 64 is disposed at a branched part between the catalyst passage part 62 and the sensor passage part 63. The changeover valve 64 switches a passage for the air discharged from the air pump 61 to the catalyst passage part 62 or the sensor passage part 63.

When the NOx sensor 36 is diagnosed, NOx concentration near the NOx sensor 36 in the exhaust passage 27 needs to be reduced. In the first embodiment, the air discharged from the air pump 37 is supplied to the upstream side of the three-way catalyst 34. An internal combustion engine sometimes includes an air pump for supplying fresh air to an exhaust passage in order to ensure the activity of a catalyst. In this case, air discharged from the air pump needs to be supplied to an upstream side of the catalyst. Accordingly, a comparatively large amount of air needs to be supplied to the exhaust passage 27 by the air pump 37, to discharge the exhaust air which remains in the exhaust passage 27 near the NOx sensor 36. In the second embodiment, a discharge side of the air pump 61 branches between the catalyst passage part 62 and the sensor passage part 63. By providing the changeover valve 64 at the branched part between the catalyst passage part 62 and the sensor passage part 63, a flow of the air discharged from the air pump 61 is switched to the upstream side of the three-way catalyst 34 or the upstream side of the NOx sensor 36. Accordingly, when the NOx sensor 36 is diagnosed, a flow of the air supplied to the exhaust passage 27 by the air pump 61 is reduced.

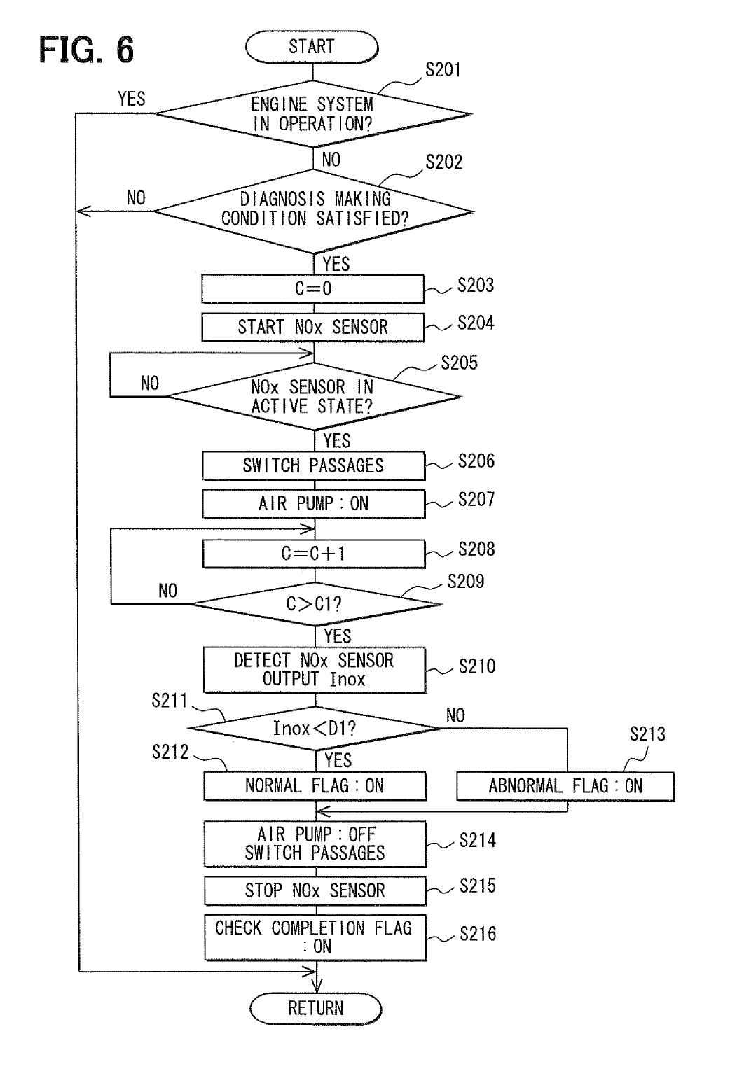

Next, a flow of abnormality determination of the NOx sensor 36 of the second embodiment is described below with reference to FIG. 6. With regard to substantially the same procedure as the first embodiment, only its outline is explained. A determination part 56 first determines whether the engine system 10 is operating (S201). If the determination part 56 determines at S201 that the engine system 10 has stopped, the determination part 56 determines whether a diagnosis making condition is satisfied (S202). Meanwhile, the determination part 56 determines whether the voltage of the battery 39 is equal to or larger than a predetermined lower limit, as the diagnosis making condition. If the determination part 56 determines at S202 that the diagnosis making condition for the NOx sensor 36 is satisfied, as described above, the determination part 56 initializes a counter, i.e., C=0 (S203). When the determination part 56 determines at S202 that the diagnosis making condition for the NOx sensor 36 is satisfied, the determination part 56 initializes the counter and starts operation of the NOx sensor 36 at S203 (S204).

The determination part 56 checks the activity of the NOx sensor 36 to determine whether the NOx sensor 36 is in an active state (S205). If the determination part 56 determines at S205 that the NOx sensor 36 is in an active state, the determination part 56 switches the passage for the air discharged from the air pump 61 to the sensor passage part 63 by the changeover valve 64 (S206). The air pump 61 supplies secondary air to the three-way catalyst 34 while the engine system 10 is in operation. Thus, if the engine system 10 is operating, the air discharged from the air pump 61 is supplied to the upstream side of the three-way catalyst 34 in the exhaust passage 27 via the catalyst passage part 62. So, the changeover valve 64 switches the passage of air to the catalyst passage part 62 while the engine system 10 is in operation. Accordingly, in diagnosing the NOx sensor 36, the determination part 56 switches the passage for the air discharged from the air pump 61 from the catalyst passage part 62 to the sensor passage part 63 by the changeover valve 64.

When the passage of air is switched by the changeover valve 64, the determination part 56 operates the air pump 61 (S207). Accordingly, the air discharged from the air pump 61 is supplied to a part of the exhaust passage 27 between the three-way catalyst 34 and the NOx sensor 36. As a result of the supply of air to the exhaust passage 27 by the air pump 61, exhaust air which remained in the exhaust passage 27, particularly, exhaust air which has remained near the NOx sensor 36, after the stop of the engine 11, is pushed out by the air supplied by the air pump 61. Upon actuation of the air pump 61, the determination part 56 advances the counter at predetermined time intervals, i.e., C=C+1 (S208) The determination part 56 continues the energization of the air pump 61 until a period of energization of the air pump 61 reaches a predetermined value C1, i.e., until a count of the counter reaches C>C1 (S209).

The determination part 56 detects an output value Inox of the NOx sensor 36 (S210), if the period of energization of the air pump 61 reaches the predetermined value C1. Then, the determination part 56 determines whether the detected output value Inox of the NOx sensor 36 is smaller than a predetermined reference value D1 (S211). If the detected output value Inox of the NOx sensor 36 is smaller than the reference value D1, the determination part 56 determines that the NOx sensor 36 is normal, and turns on a normal flag (S212). On the other hand, if the detected output value Inox of the NOx sensor 36 is equal to or larger than the reference value D1, the determination part 56 determines that the NOx sensor 36 is abnormal, and turns on an abnormal flag (S213).

The determination part 56 stops the air pump 61 (S214) after the determination part 56 turns on the normal flag at S212 or turns on the abnormal flag at S213. Additionally, the determination part 56 switches the passage for the air discharged from the air pump 61 from the sensor passage part 63 to the catalyst passage part 62 by the changeover valve 64. Accordingly, when the engine system 10 is restarted, the secondary air is supplied to the three-way catalyst 34 by the air pump 61 if required. Then, the determination part 56 stops the operation of the NOx sensor 36 (S215). After that, the determination part 56 turns on a check completion flag (S216). Accordingly, the diagnosis of the NOx sensor 36 is completed.

In the above manner, in the second embodiment, the passage of air on a discharge side of the air pump 61 is switched by the changeover valve 64 to the catalyst passage part 62 or the sensor passage part 63 In diagnosing the NOx sensor 36, exhaust air needs to be removed near the NOx sensor 36. When air is supplied to the upstream side of the three-way catalyst 34 by the air pump 61, such as in the normal case of the supply of the secondary air, air corresponding to the volume from the three-way catalyst 34 to the NOx sensor 36 needs to be excessively supplied, despite the diagnosis of the NOx sensor 36. The air pump 61 has comparatively large power consumption. In the second embodiment, the air discharged from the air pump 61 is supplied to the vicinity of the NOx sensor 36. Accordingly, the excessive air corresponding to the volume from the three-way catalyst 34 to the NOx sensor 36 does not need to be supplied. For this reason, it is only necessary to supply minimum air that is needed for the diagnosis of the NOx sensor 36 by the air pump 61. As a result, the NOx sensor 36 is diagnosed in a shorter period of time, and the power consumption of the air pump 61 is reduced.

The invention described above is not limited to the above embodiments, and may be applied to various embodiments without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A NOx sensor diagnostic device for an internal combustion engine having an exhaust passage, the device comprising:
a NOx sensor disposed in the exhaust passage, through which exhaust air discharged from the engine flows, and configured to detect nitrogen oxide included in the exhaust air;
an air supply means for supplying air to the exhaust passage; and
a sensor determination means for making the NOx sensor detect nitrogen oxide in the exhaust passage, to which air is supplied by the air supply means while the engine is stopped, and for determining that the NOx sensor is abnormal when an output value of the NOx sensor is equal to or larger than a predetermined reference value.

2. The NOx sensor diagnostic device according to claim 1, further comprising a catalyst disposed on an upstream side of the NOx sensor in a flow direction of the exhaust air in the exhaust passage, the catalyst being capable of purifying the exhaust air flowing through the exhaust passage, wherein the air supply means includes:
an air pump configured to supply air to the exhaust passage;
a catalyst-side passage part connecting the air pump and an upstream side of the catalyst in the flow direction of the exhaust air, wherein the air discharged from the air pump flows along the catalyst-side passage part;
a sensor-side passage part connecting the air pump and a downstream side of the catalyst in the flow direction of the exhaust air, wherein the air discharged from the air pump flows along the sensor-side passage part; and
a changeover valve configured to switch a flow of the air discharged from the air pump to the catalyst-side passage part or the sensor-side passage part, wherein the changeover valve switches the flow of the air discharged from the air pump to the sensor-side passage part when the sensor determination means determines whether the NOx sensor is abnormal.

3. The NOx sensor diagnostic device according to claim 1, further comprising a valve means for opening or closing a suction passage of the engine, along which suction air suctioned into the engine flows, wherein the valve means closes the suction passage when the sensor determination means determines whether the NOx sensor is abnormal.

4. The NOx sensor diagnostic device according to claim 1, further comprising a battery configured to supply electrical power to the air supply means, wherein the sensor determination means stops the determination of the abnormality of the NOx sensor when voltage of the battery is equal to or smaller than a predetermined voltage.
